(19) United States
(12) Patent Application Publication
(10) Pub. No.: US 2022/0324310 A1
(43) Pub. Date: Oct. 13, 2022

(54) COMPOSITE LIFT GATE

(71) Applicant: GM GLOBAL TECHNOLOGY OPERATIONS LLC, Detroit, MI (US)

(72) Inventors: Venkateshwar R. AITHARAJU, Troy, MI (US); Gurpinder S. DHALIWAL, Farmington Hills, MI (US); Erik B. GOLM, Warren, MI (US); Princess Len M. CARLOS, Sterling Heights, MI (US); Donald E. MATTHEWS, Royal Oak, MI (US); James K. SCHOENOW, Frankenmuth, MI (US)

(73) Assignee: GM GLOBAL TECHNOLOGY OPERATIONS LLC, Detroit, MI (US)

(21) Appl. No.: 17/226,942

(22) Filed: Apr. 9, 2021

(51) Int. Cl. B60J 5/10; B32B 7/09; B32B 5/06; B32B 15/02; B32B 15/14

(52) U.S. Cl. CPC B60J 5/107; B32B 7/09; B32B 5/06; B32B 15/02; B32B 15/14; B32B 2260/023; B32B 2260/046; B32B 2262/103; B32B 2307/206

(57) ABSTRACT

The present disclosure provides a composite lift gate for a vehicle. The composite lift gate includes a polymer matrix and a fiber assembly. The fiber assembly is embedded in the polymer matrix. The fiber assembly includes a fiber mat and a plurality of substantially-aligned continuous fibers. The plurality of substantially-aligned continuous fibers is directly connected to a portion of the fiber mat. In one aspect, the composite lift gate further includes an electronic component connected to the fiber assembly. In various aspects, the present disclosure provides a method of manufacturing a composite lift gate for a vehicle.

### INTRODUCTION

This section provides background information related to the present disclosure which is not necessarily prior art.

The present disclosure relates to a composite lift gates for vehicles and methods of manufacturing composite lift gates.

It is advantageous that components of automobiles or other vehicles be lightweight to improve fuel efficiency. However, it is also advantageous that such components exhibit adequate strength during use. Polymeric composite components may be desirably lightweight while exhibiting high strength.

### SUMMARY

This section provides a general summary of the disclosure, and is not a comprehensive disclosure of its full scope or all of its features.

In various aspects, the present disclosure provides a composite lift gate for a vehicle. The composite lift gate includes a polymer matrix and a fiber assembly. The fiber assembly is embedded in the polymer matrix. The fiber assembly includes a fiber mat and a plurality of substantially-aligned continuous fibers. The plurality of substantially-aligned continuous fibers is directly connected to a portion of the fiber mat.

In one aspect, the plurality of substantially-aligned continuous fibers include a first plurality of substantially-aligned continuous fibers, a second plurality of substantially-aligned continuous fibers, a third plurality of substantially-aligned continuous fibers, and a fourth plurality of substantially-aligned continuous fibers. The first, second, third, and fourth pluralities of substantially-aligned continuous fibers are arranged (i) in an M-shape, (ii) in a W-shape, or (iii) around a periphery of the composite lift gate.

In one aspect, the fiber assembly further includes a metal mesh directly connected to the fiber mat.

In one aspect, the fiber mat includes a first layer and a second layer. The metal mesh is disposed between the first layer and the second layer.

In one aspect, the wire mesh includes wires having a diameter of greater than or equal to about 0.2 mm to less than or equal to about 0.5 mm. The wire mesh defines a mesh spacing of greater than or equal to about 1 inch to less than or equal to about 4 inches.

In one aspect, the wire mesh is stitched to the fiber mat.

In one aspect, the plurality of substantially-aligned continuous fibers include a first portion having a first volume fraction and a second portion having a second volume fraction different than the first volume fraction.

In one aspect, the plurality of substantially-aligned continuous fibers includes a first portion and a second portion. The first portion has a first thickness and the second portion has a second thickness different than the first thickness.

In one aspect, the composite lift gate further includes a metal reinforcement component. The metal reinforcement component is directly connected to the fiber mat, the plurality of substantially-aligned continuous fibers, or both the fiber mat and the plurality of substantially-aligned continuous fibers. The metal reinforcement component is at least partially embedded in the polymer matrix.

In one aspect, the metal reinforcement component is stitched to the fiber mat.

In one aspect, the present disclosure provides a composite lift gate assembly. The assembly includes the composite lift gate, a tether, a first panel, and a second panel. The tether includes a first end coupled to a first region of the composite lift gate and a second end coupled to a second region of the composite lift gate. The second region is different than the first region. The composite lift gate and the tether are disposed between the first panel and the second panel.

In one aspect, the tether includes fabric.

In one aspect, the fiber mat includes a chopped fiber mat, a non-crimp fabric, or both a chopped fiber mat and a non-crimped fabric.

In one aspect, the polymer matrix includes a thermoset polymer.

In one aspect, the composite lift gate further includes an electronic component connected to the fiber assembly. The electronic component being selected from the group consisting of: a sensor, a switch, or any combination thereof, wherein the electronic component is at least partially embedded in the polymer matrix.

In one aspect, the composite lift gate further includes an electrically-insulating material configured to insulate the electronic component from the fiber assembly.

In various aspects, the present disclosure provides a method of manufacturing a composite lift gate for a vehicle. The method includes preparing a fiber preform by connecting a plurality of substantially-aligned continuous fibers to a fiber mat. The method further includes disposing the fiber preform in a mold. The method further includes injecting a polymer precursor into the mold. The method further includes forming the composite lift gate by crosslinking the polymer precursor to form a polymer matrix. The fiber preform is embedded in the polymer matrix.

In one aspect, the preparing further includes directly connecting a metal mesh to the fiber mat.

In one aspect, the method further includes prior to the injecting, connecting a metal reinforcement component to the fiber preform.

In one aspect, the method further includes, prior to the injecting, connecting an electronic component to the fiber preform.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic view of a lift gate according to various aspects of the present disclosure;

FIG. 2 is a partial sectional view of a lift gate assembly according to various aspects of the present disclosure;

FIGS. 3A-3D relate to a lift gate including substantially-aligned continuous fibers according to various aspects of the present disclosure; FIG. 3A is a front view of the lift gate; FIG. 3B is a partial sectional view taken at line 3B-3B of FIG. 3A; FIG. 3C is a partial sectional view taken at line 3C-3C of FIG. 3A; and FIG. 3D is a partial sectional view taken at line 3D-3D of FIG. 3A;

FIG. 4 is a front view of a lift gate having M-shaped strengthening according to various aspects of the present disclosure;

FIG. 5 is a front view of a lift gate having W-shaped strengthening according to various aspects of the present disclosure;

FIG. 6 is a front schematic view of a lift gate including a mesh support according to various aspects of the present disclosure;

FIGS. 7A-7B relate to a lift gate having variable fiber density according to various aspects of the present disclosure; FIG. 7A is a perspective view of the lift gate; FIG. 7B is a detail perspective view of a latch region of the lift gate;

FIG. 8 is a partial sectional view of a lift gate and a latch according to various aspects of the present disclosure;

FIG. 9 is a partial perspective view of a lift gate assembly including a tether according to various aspects of the present disclosure;

FIG. 10 is a partial perspective view of a lift gate including a latch reinforcement according to various aspects of the present disclosure;

FIGS. 11A-11C relate to a lift gate having integrally molded electronic components; FIG. 11A is a perspective view of the lift gate; FIG. 11B is a front partial view of the lift gate having a sensor; FIG. 11C is a partial perspective view of the lift gate having a switch; and

FIG. 12 is a flowchart depicting a method of manufacturing a composite lift gate according to various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

Vehicle lift gates may be formed from metal and/or fiber-polymer composites, such as a thermoplastic matrix having embedded short reinforcing fibers. Lift gates may be formed by injection molding and subsequently undergo post-processing to attach reinforcements, hardware, and/or electronics. Accordingly, a manufacturing process may be complex, requiring multiple steps and/or transport between different manufacturing and assembly locations. Moreover, as thickness of the lift gate is increased to increase its strength, a weight of the lift gate also increases.

In various aspects, the present disclosure provides a composite lift gate for a vehicle. The composite lift gate includes a fiber assembly embedded in a polymer matrix. The fiber assembly includes a fiber mat and one or more pluralities of substantially-aligned continuous fibers in predetermined local regions, such as regions expected to be subjected to repeated use and/or high loads. The continuous fibers may have a variable fiber volume fraction and/or thickness for tailored strengthening. For example, the lift gate may include a higher volume fraction of continuous fibers and/or increased thickness in regions that are expected to experience frequent use and/or high loads. One or more additional components may be connected to and integrally molded with the fiber assembly, such as a wire support, one or more reinforcements, and one or more electronic components.

The local regions of continuous fibers and discrete reinforcements may provide high strength in desired areas while maintaining a relatively low total weight of the lift gate (compared to a lift gate formed from metal or having continuous fibers, large high thickness, and/or reinforcements throughout). Integral molding of wire mesh, reinforcements, and/or electronic components may facilitate retention of the components to the lift gate and a streamlined manufacturing process. The wire mesh may facilitate retention of the lift gate in a single piece or few pieces in the case of an impact event. The composite lift gate may also include a tether to facilitate retention of the lift gate to the vehicle during an impact event.

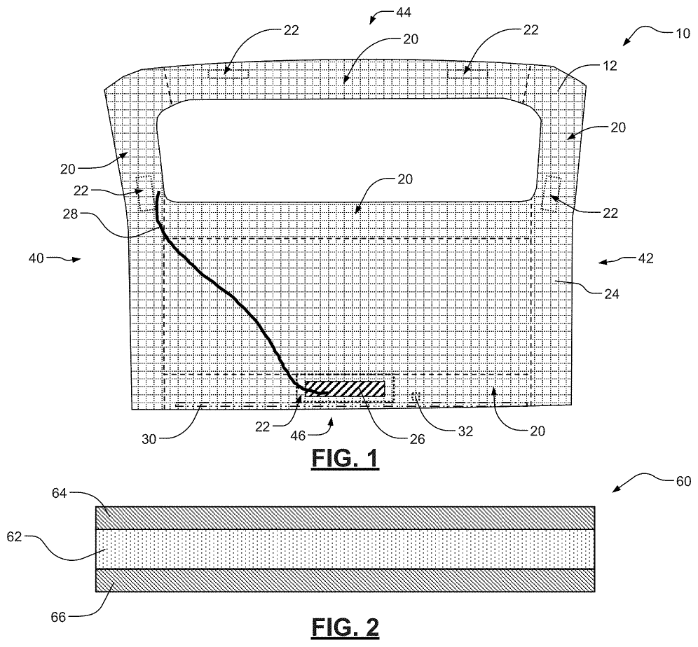

With reference to FIG. 1, a composite lift gate 10 according to various aspects of the present disclosure is provided. The composite lift gate 10 includes a body 12 including a polymer matrix and a fiber assembly embedded in the polymer matrix. The fiber assembly includes a fiber mat.

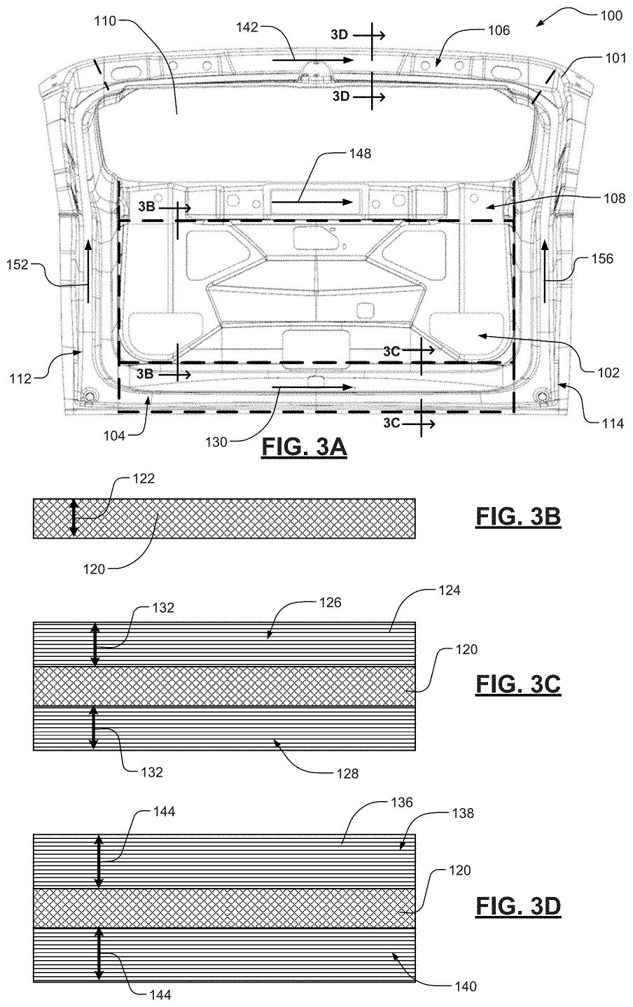

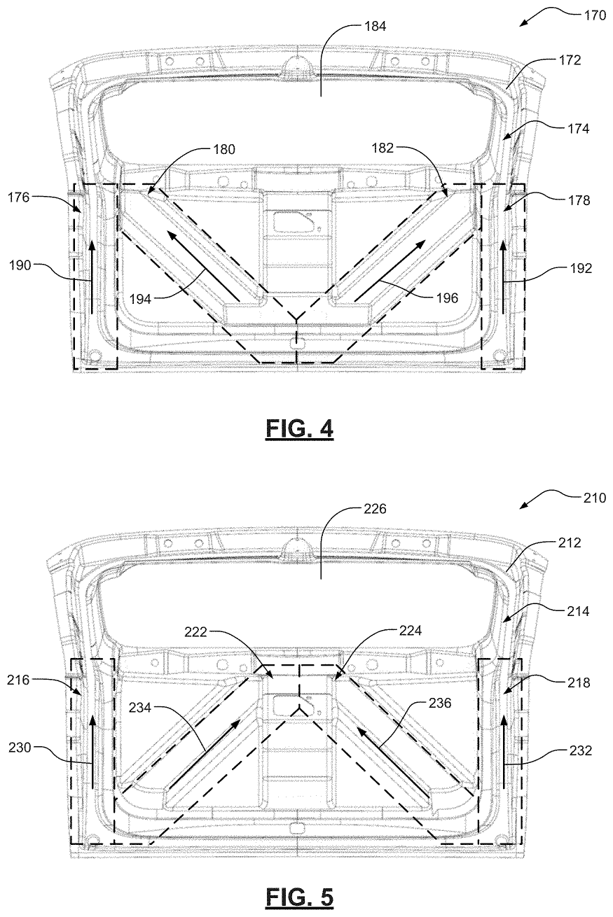

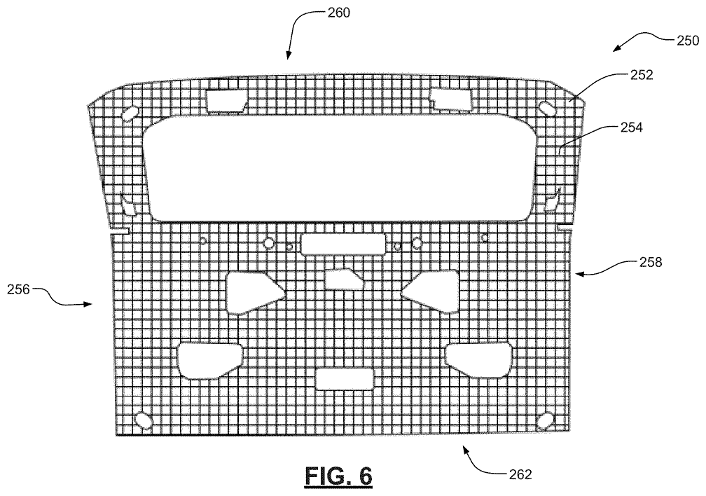

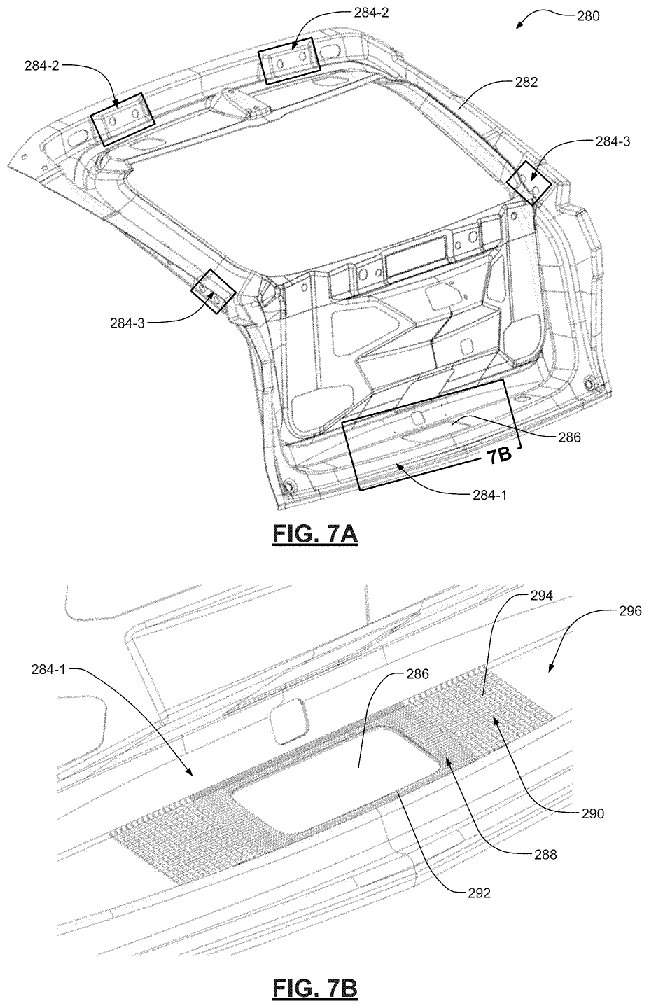

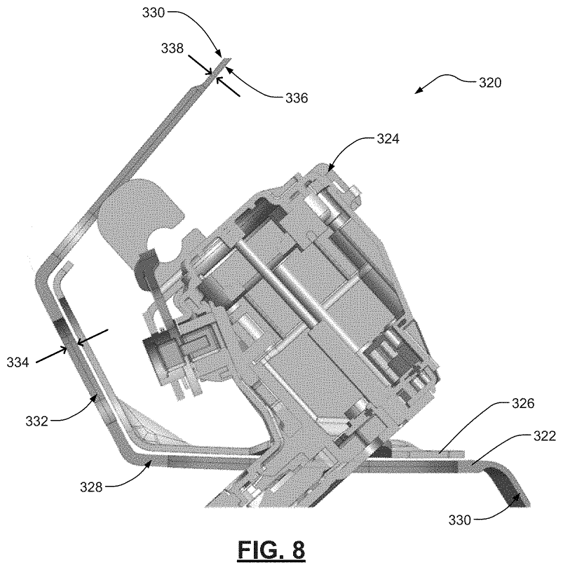

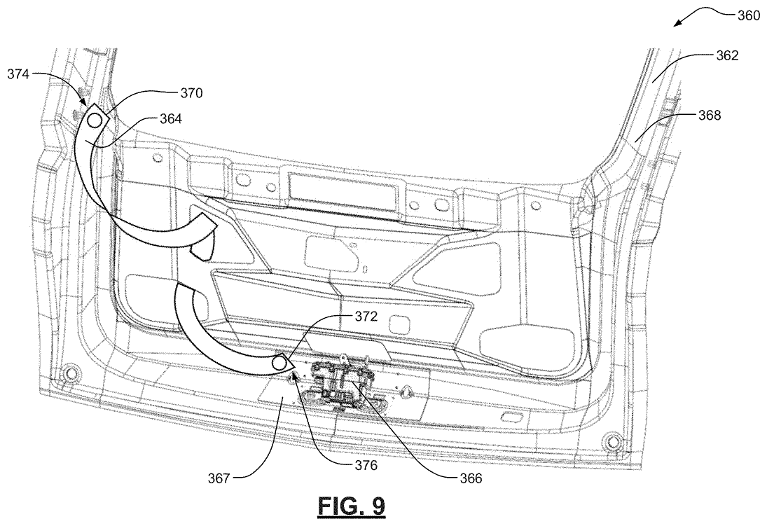

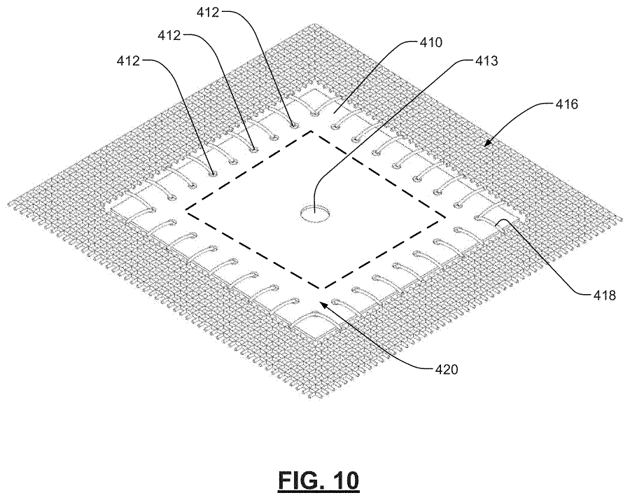

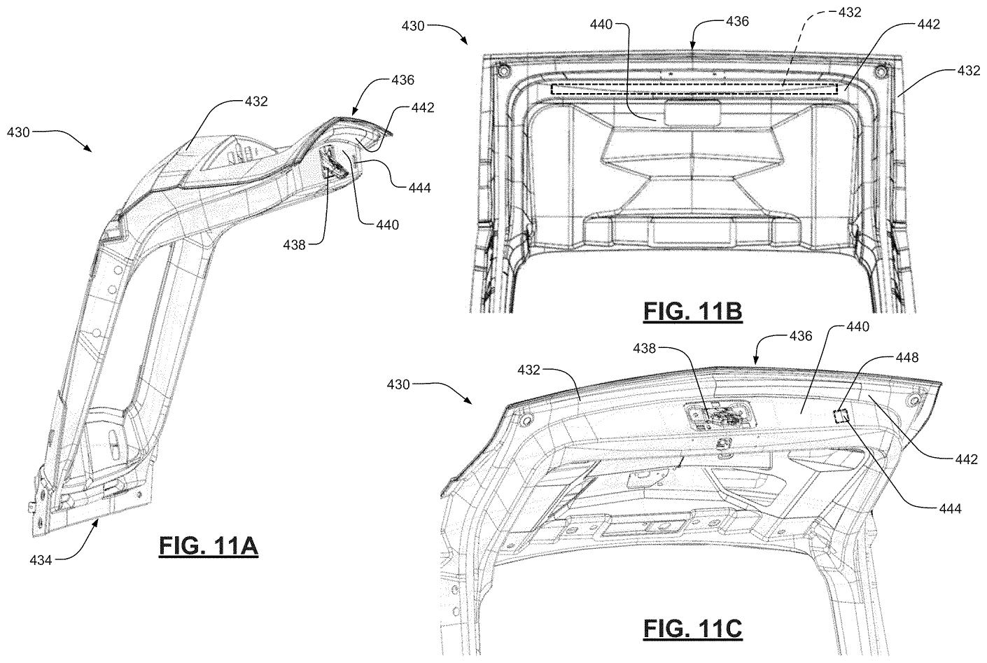

The fiber assembly may further include or be connected to one or more additional features or components, such as one or more pluralities of substantially-aligned continuous fibers in predetermined regions 20 of the body 12 (see also FIGS. 3A-5), which may have variable density and/or thickness in sub-regions 22 (see also FIGS. 7A-8); a mesh support 24 (see also FIG. 6); one or more reinforcement components 26 (see also FIG. 10); one or more tethers 28 (see also FIG. 9); one or more electronic components (see also FIGS. 11A-11C), such as sensor(s) 30 and/or switch(es) 32, or any combination thereof. Each of these features is described in greater detail below. Although the composite lift gate 10 includes all of the foregoing features, and the features are individually shown in the following figures, a composite lift gate according to certain aspects of the present disclosure may include any sub-combination of the foregoing features.

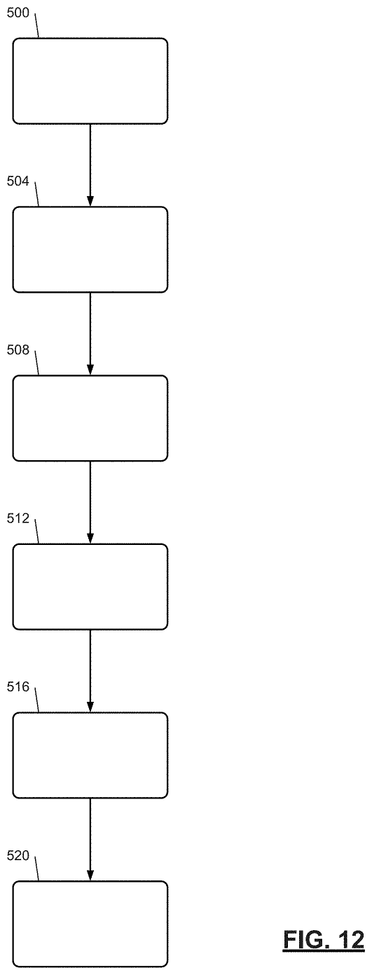

As will be described in greater detail below in the discussion accompanying FIG. 12, the additional features and/or components may be integrally molded with the fiber mat, such as in a resin transfer molding (RTM) process, and at least partially embedded in the polymer matrix. Accordingly, the composite lift gate 10 may have increased strength, increased retention of additional components, and a simplified manufacturing process compared to injected molded lift gates that require post processing.

The fiber mat, which may also be referred to as a base, may extend through substantially the entire body 12. For example, the fiber mat may extend between a first or driver side 40 of the body 12 and a second or passenger side 42 of the body 12. The fiber mat may also extend between a top 44 of the body 12 and a bottom 46 of the body 12.

The fiber mat may include a chopped fiber mat, a non-crimp fabric (NCF), a woven fiber mat, or a combination thereof. The fiber mat may include one or more layers. By way of example, the fiber mat may include greater than or equal to two layers, greater than or equal to three layers, greater than or equal to four layers, greater than or equal to five layers, greater than or equal to six layers, greater than or equal to eight layers, greater than or equal to ten layers, or greater than or equal to fifteen layers. In certain aspects, fibers of the fiber mat may extend in multiple different directions. For example, layers of the fiber mat may be arranged to have different fiber orientations. Fibers in a single layer of the fiber may be disposed in a single direction (e.g., in a NCF), two directions (e.g., in a woven fabric mat), or more than two different directions (e.g., in a chopped fiber mat).

In certain aspects, the chopped mat may include fibers that have a mean fiber length of less than about 2 inches, optionally greater than or equal to about 50 μm to less than or equal to about 2 inches, or optionally greater than or equal to about 0.5 inch to less than or equal to about 2 inches. The fibers of the chopped fiber mat may be multi-directional, such as randomly oriented.

In certain aspects, different layers of the NCF may be arranged at different orientations, such as +45°, −45°, 0°, 90°, or other angles. For example, the layers may be alternatingly disposed at two different angles, such as +45° and −45°. In certain aspects, fibers of the NCF may be straight, continuous fibers. Continuous fibers may have lengths of greater than about 50 mm optionally greater than or equal to about 100 mm, optionally greater than or equal to about 250 mm, optionally greater than or equal to about 0.5 m, optionally greater than or equal to about 1 m, optionally greater than or equal to about 1.5 m, or optionally greater than or equal to about 2 m.

In certain aspects, the woven fabric may provide bi-directional reinforcement. For example, the woven fabric may include a first portion of fibers extending in a first direction woven with a second plurality of fibers extending in a second direction. The first and second directions may be substantially perpendicular. Continuous fibers of the woven fabric may have lengths of greater than about 50 mm optionally greater than or equal to about 100 mm, optionally greater than or equal to about 250 mm, optionally greater than or equal to about 0.5 m, optionally greater than or equal to about 1 m, optionally greater than or equal to about 1.5 m, or optionally greater than or equal to about 2 m.

In contrast to the fiber mat, the continuous fibers of each plurality of the substantially-aligned continuous fibers extend substantially in a single direction and may be referred to as uni-directional continuous fibers or 0° continuous fibers. In certain aspects, the composite lift gate 10 may include multiple pluralities of substantially-aligned continuous fibers, with different pluralities being disposed in different regions and extending in different single directions, as described in greater detail below. The pluralities of continuous fibers may have relatively high strengths and stiffnesses in a single direction compared to fibers of the fiber may. Accordingly, each plurality of substantially-aligned continuous fibers may provide an anisotropic reinforcement phase. The continuous fibers of the pluralities of substantially-aligned continuous fibers may have lengths of greater than about 50 mm optionally greater than or equal to about 100 mm, optionally greater than or equal to about 250 mm, optionally greater than or equal to about 0.5 m, optionally greater than or equal to about 1 m, optionally greater than or equal to about 1.5 m, or optionally greater than or equal to about 2 m. In certain aspects, the substantially-aligned continuous fibers may be provided in bundles. In one example, the fibers are provided in a 24,000-25,000 filament per bundle tow.

The one or more pluralities of substantially-aligned continuous fibers may extend through a portion of the body 12 (e.g., less than the entire body 12 and less than the fiber mat), as will be described in greater detail below (see FIGS. 3A-5 and accompanying discussion). For example, the substantially-aligned continuous fibers may be disposed in regions of the body 12 that are more likely to be subjected to repeated use and/or high loads (e.g., during ordinary use or an impact event). The substantially-aligned continuous fibers may have orientations that are tailored based on expected loads.

The fibers of the fiber mat and/or the substantially-aligned continuous fibers may include carbon fibers, glass fibers (e.g., fiber glass, quartz), basalt fibers, aramid fibers (e.g., KEVLAR®, polyphenylene benzobisoxazole (PBO)), polyethylene fibers (e.g., high-strength ultra-high molecular weight (UHMW) polyethylene), polypropylene fibers (e.g., high-strength polypropylene), natural fibers (e.g., cotton, flax, cellulose, spider silk, hemp, jute), or any combination thereof, by way of example. The fiber mat and the substantially-aligned continuous fibers may include the same types of fibers or different types of fibers. When the body 12 includes multiple pluralities of substantially-aligned continuous fibers, the different pluralities may include the same type of fibers or different types of fibers.

The polymer matrix may include a thermoset polymer or a thermoplastic polymer. Suitable thermoset polymers may include benzoxazine, a bis-maleimide (BMI), a cyanate ester, an epoxy, a phenolic (PF), a polyacrylate (acrylic), a polyimide (PI), an unsaturated polyester, a polyeurethane (PUR), a vinyl ester, a siloxane, co-polymers thereof, and combinations thereof. Suitable thermoplastic polymers may include polyethylenimine (PEI), polyamide-imide (PAI), polyamide (PA) (e.g., nylon 6, nylon 66, nylon 12), caprolactam, polyetheretherketone (PEEK), polyetherketone (PEK), a polyphenylene sulfide (PPS), a thermoplastic polyurethane (TPU), polypropylene (PP), polycarbonate/acrylonitrile butadiene styrene (PC/ABS), high-density polyethylene (HDPE), polyethylene terephthalate (PET), poly(methyl methacrylate) (PMMA), polycarbonate (PC), polyaryletherketone (PAEK), polyetherketoneketone (PEKK), co-polymers thereof, and combinations thereof.

Referring to FIG. 2, a sectional view of a lift gate assembly 60 according to various aspects of the present disclosure is provided. The section may be taken through a thickness (i.e., smallest dimension) of the lift gate assembly 60. The lift gate assembly 60 includes a lift gate 62 between a first or interior panel 64 and a second or exterior panel 66. The interior panel 64 may face an interior of a vehicle and conceal the lift gate 62 from the interior of the vehicle. The exterior panel 66 may face an exterior of the vehicle and conceal the lift gate 62 from the exterior of the vehicle.

With reference to FIG. 3A, in various aspects, the present disclosure provides a lift gate 100. The lift gate 100 includes a body 101 including a polymer matrix and a fiber assembly embedded in the polymer matrix. The fiber assembly may include a fiber mat and one or more pluralities of substantially aligned or uni-directional continuous fibers. The fiber mat may extend across substantially the entire body 101, as described above in the discussion accompanying FIG. 1. The pluralities of substantially-aligned continuous fibers are present on portions of the body 101, as described in greater detail below.

The body 101 of the lift gate 100 may include different regions having different expected loads. For example, the body 101 may have a first region 102 located in a central portion of the body 101, a second region 104 located along a bottom portion of the body 101, a third region 106 located a top portion of the body 101, a fourth region 108 located at a portion of the body 101 between the first region 102 and a rear window opening 110, a fifth region 112 on a driver side, and a sixth region 114 on a passenger side.

The second, third, fifth, and sixth regions 104, 106, 112, 114 may cooperate to define a periphery of the body 101. The second, third, fourth, fifth, and sixth regions 104, 106, 108, 112, 114 may be expected to experience higher loads than the first region 102. Accordingly, in certain aspects, each of the second, third, fourth, fifth, and sixth regions 104, 106, 108, 112, 114 may include a plurality of substantially-aligned continuous fibers. The pluralities of substantially-aligned continuous fibers may have the same thicknesses or different thicknesses. In certain aspects, each plurality of substantially-aligned continuous fibers may define a thickness of greater than or equal to about 0.8 mm to less than or equal to about 4, or optionally greater than or equal to about 0.8 mm to less than or equal to about 2 mm. Each plurality of substantially-aligned continuous may include a single layer or a plurality of layers. In certain aspects, a plurality of substantially-aligned continuous fibers may include greater than or equal to one layer, optionally greater than or equal to two layers, optionally greater than or equal to three layers, optionally greater than or equal to four layers, optionally greater than or equal to five layers, optionally greater than or equal to six layers, optionally greater than or equal to eight layers, optionally greater than or equal to ten layers, optionally greater than or equal to fifteen layers, optionally greater than or equal to twenty layers.

In certain aspects, the substantially-aligned continuous fibers are connected to the fiber mat. The substantially-aligned continuous fibers may be directly connected to the fiber mat. In certain aspects, the substantially-aligned continuous fibers may be connected as stacked, integrally molded layers. In certain aspects, the substantially-aligned continuous fibers may be coupled to the fiber mat, such as by stitching, adhesive, tack-welding, bonding, such as with thermoplastic binder (e.g., applied with heat and/or pressure), or any combination thereof, by way of example. The substantially-aligned continuous fibers may be on a single side of the fiber mat of both sides of the fiber mat (i.e., with the fiber mat between two portions of the substantially-aligned continuous fibers).

FIG. 3B is a partial sectional view of the first region 102. The first region 102 includes a fiber mat 120. The first region 102 may be substantially free of the substantially-aligned continuous fibers. In an example, the fiber mat 120 includes a plurality of layers of NCF with +/−45° angles. The fiber mat 120 may define a first thickness 122 of greater than or equal about 0.6 mm to less than or equal to about 1.2 mm, or optionally greater than or equal about 0.6 mm to less than or equal to about 0.8 mm. In an example, when the first region 102 includes only the fiber mat 120, a total thickness of the first region 102 may be about 0.8 mm.

FIG. 3C is a partial sectional view of the second region 104. The second region 104 includes the fiber mat 120 and a first plurality of substantially-aligned continuous fibers 124. The fiber mat 120 is between first and second portions 126, 128 of the first plurality of substantially-aligned continuous fibers 124. The first plurality of substantially-aligned continuous fibers 124 is substantially parallel to a first direction 130. In certain aspects, the first direction 130 may be substantially horizontal. The first and second portions 126, 128 may each define a second thickness 132. In an example, a total thickness of the first and second portions 126, 128 (i.e., two times the second thickness 132) may be about 2.2 mm. Therefore, when the first thickness is about 0.8 mm, a total thickness of the second region 104 may be about 3 mm.

FIG. 3D is a partial sectional view of the third region 106. The third region 106 includes the fiber mat 120 and a second plurality of substantially-aligned continuous fibers 136. The fiber mat 120 is between first and second portions 138, 140 of the second plurality of substantially-aligned continuous fibers 136. The second plurality of substantially-aligned continuous fibers 136 may be substantially parallel to a second direction 142. In certain aspects, the second direction 142 may be substantially horizontal. The first and second portions 138, 140 may each define a third thickness 144. In an example, a total thickness of the first and second portions 138, 140 (i.e., two times the third thickness 144) may be about 1.8 mm. Therefore, when the first thickness 122 is about 0.8 mm, a total thickness of the third region 106 may be about 2.6 mm.

Returning to FIG. 3A, the fourth region 108 may include the fiber mat 120 (FIGS. 3B-3D) and a third plurality of substantially-aligned continuous fibers (not shown) substantially parallel to a third direction 148. The third direction 148 may be substantially horizontal. In certain aspects, the fourth region 108 may have a similar arrangement, thicknesses, and layers as the third region 106.

The fifth region 112 may include the fiber mat 120 (FIGS. 3B-3D) and a fourth plurality of substantially-aligned continuous fibers substantially parallel to a fourth direction 152. The fourth direction 152 may be substantially vertical. In certain aspects, the fifth region 112 may have a similar arrangement, thicknesses, and layers as the third region 106.

The sixth region 114 may include the fiber mat 120 (FIGS. 3B-3D) and a fifth plurality of substantially-aligned continuous fibers (not shown) substantially parallel to a fifth direction 156. The fifth direction 156 may be substantially vertical. In certain aspects, the sixth region 114 may have a similar arrangement, thicknesses, and layers as the third region 106.

With reference to FIG. 4, the present disclosure provides a lift gate 170 according to various aspects of the present disclosure. The lift gate 170 includes a body 172 including a polymer matrix and a fiber assembly embedded in the polymer matrix. The fiber assembly may include a fiber mat and one or more pluralities of substantially aligned or uni-directional continuous fibers. The fiber mat may extend across substantially the entire body 172, as described above in the discussion accompanying FIG. 1. The pluralities of substantially-aligned continuous fibers are present on portions of the body 172, as described in greater detail below.

The body 172 may include a first region 174, a second region 176, a third region 178, a fourth region 180, and a fifth region 182. The second region 176 extends along at least a portion of a driver side. The third region 178 extends along at least a portion of a passenger side. The fourth region 180 extends between a bottom driver-side corner of a rear window opening 184 and a bottom center portion of the body 172. The fifth region 182 extends between a bottom passenger-side corner of the rear window opening 184 and the bottom center portion of the body 172. The second, third, fourth, and fifth regions 176, 178, 180, 182 may cooperate to define an M-shape. In certain aspects, the M-shaped region may be considered to be a single region rather than four separate regions.

The second, third, fourth, and fifth regions 176, 178, 180, 182 may be expected to experience higher loads than the first region 174. Accordingly, in certain aspects, the first region 174 may include only the fiber mat. Except for shape, the first region 174 may be similar to the first region 102 of FIGS. 3A-3B.

The second, third, fourth, and fifth regions 176, 178, 180, 182 may each include both the fiber mat and a plurality of substantially-aligned continuous fibers. The second region 176 may include a first plurality of substantially-aligned continuous fibers substantially parallel to a first direction 190. The third region 178 may include a second plurality of substantially-aligned continuous fibers substantially parallel to a second direction 192. The fourth region 180 may include a third plurality of substantially-aligned continuous fibers substantially parallel to a third direction 194. The fifth region 182 may include a fourth plurality of substantially-aligned continuous fibers substantially parallel to a fourth direction 196.

Referring to FIG. 5, the present disclosure provides a lift gate 210 according to various aspects of the present disclosure. The lift gate 210 includes a body 212 including a polymer matrix and a fiber assembly embedded in the polymer matrix. The fiber assembly may include a fiber mat and one or more pluralities of substantially aligned or uni-directional continuous fibers. The fiber mat may extend across substantially the entire body 212, as described above in the discussion accompanying FIG. 1. The pluralities of substantially-aligned continuous fibers are present on portions of the body 212, as described in greater detail below.

The body 212 may include a first region 214, a second region 216, a third region 218, a fourth region 220, and a fifth region 222. The second region 216 extends along at least a portion of a driver side. The third region 218 extends along at least a portion of a passenger side. The fourth region 220 extends between a bottom driver-side corner of a rear window opening 224 and a bottom center portion of the body 212. The fifth region 222 extends between a bottom passenger-side corner of the rear window opening 224 and the bottom center portion of the body 212. The second, third, fourth, and fifth regions 216, 218, 220, 222 may cooperate to define an W-shape. In certain aspects, the W-shaped region may be considered to be a single region rather than four separate regions.

The second, third, fourth, and fifth regions 216, 218, 220, 222 may be expected to experience higher loads than the first region 214. Accordingly, in certain aspects, the first region 214 may include only the fiber mat. Except for shape, the first region 214 may be similar to the first region 102 of FIGS. 3A-3B.

The second, third, fourth, and fifth regions 216, 218, 220, 222 may each include both the fiber mat and a plurality of substantially-aligned continuous fibers. The second region 216 may include a first plurality of substantially-aligned continuous fibers substantially parallel to a first direction 230. The third region 218 may include a second plurality of substantially-aligned continuous fibers substantially parallel to a second direction 232. The fourth region 220 may include a third plurality of substantially-aligned continuous fibers substantially parallel to a third direction 234. The fifth region 222 may include a fourth plurality of substantially-aligned continuous fibers substantially parallel to a fourth direction 236.

With reference to FIG. 6, a lift gate 250 according to various aspects of the present disclosure. The lift gate 250 includes a body 252 including a polymer matrix and a fiber assembly embedded in the polymer matrix. The fiber assembly includes a fiber mat and a mesh support, such as a wire mesh 254. Accordingly, the mesh support is integrally molded with the fiber mat. In certain aspects, the fiber assembly may further include a plurality of substantially-aligned continuous fibers.

The wire mesh 254 may extend over substantially the entire body 252. For example, the wire mesh 254 may extend between a first or driver side 256 and a second or passenger side 258 and between a top 260 and a bottom 262 of the body 252. The wire mesh 254 may facilitate retention of the lift gate to a vehicle body, such as during an impact event, by providing a high strength connection point for coupling the lift gate 250 to the vehicle body. The wire mesh 254 may also facilitate retention of the body 252 in a single piece, thereby reducing or preventing separation of the lift gate 250 into multiple pieces, such as in an impact event.

The wire mesh 254 is connected to the fiber mat. The wire mesh 254 may be directly connected to the fiber mat. In certain aspects, the wire mesh 254 is between layers of the fiber mat, such as in a center of the fiber mat. In other aspects, the wire mesh 254 may be on a single side of the fiber mat or both sides of the fiber mat such that the fiber mat is between two wire meshes 254. The wire mesh 254 may be retained in connection with the fiber mat by friction (e.g., when the wire mesh is between layers of the fiber mat) or molding, for example. In certain aspects, the wire mesh 254 is coupled to the fiber mat, such as by stitching, adhesive, tack-welding, bonding, such as with thermoplastic binder (e.g., applied with heat and/or pressure), or any combination thereof, by way of example.

The wire mesh 254 may define a wire diameter of greater than or equal to 0.2 mm to less than or equal to 0.5 mm, such as greater than or equal to 0.2 mm to less than or equal to 0.3 mm, greater than or equal to 0.3 mm to less than or equal to 0.4 mm, or greater than or equal to 0.4 mm to less than or equal to 0.5 mm. The wire mesh 254 may define a mesh spacing of greater than or equal to 1 inch to less than or equal to about 4 inches, such as greater than or equal to 1 inch to less than or equal to about 2 inches, greater than or equal to 2 inch to less than or equal to about 3 inches, or greater than or equal to 3 inch to less than or equal to about 4 inches. The wire mesh 254 may include steel, stainless steel, aluminum, copper, bronze, or any combination thereof. In certain aspects, the wire mesh 254 additionally or alternatively includes a magnetic material, such as nickel, cobalt, or any combination thereof. The inclusion of a magnetic material in the wire mesh 254 may provide electromagnetic shielding (EMI) for any electronic components on or near the lift gate 250.

Referring to FIG. 7A, a lift gate 280 according to various aspects of the present disclosure is provided. The lift gate 280 includes a body 282 including a polymer matrix and a fiber assembly embedded in the polymer matrix. The fiber assembly includes a fiber mat and a plurality of substantially-aligned continuous fibers, such as those described above in the discussions accompanying FIGS. 1 and 2A-4.

In various aspects, the substantially-aligned continuous fibers may be present in the body 282 at variable volume fractions. For example, regions of the body 282 that are expected to be subjected to higher loads may have a higher volume fraction of the substantially-aligned continuous fibers than regions of the body 282 that are expected to be subjected to lower loads. In certain aspects, the fiber mat may have a substantially uniform volume fraction of fibers throughout the entire body 282. In certain aspects, providing the continuous fibers at variable volume fractions allows for incorporation of tailored high-strength areas while reducing or minimizing overall weight of the composite lift gate 280.

The lift gate 280 may include one or more reinforcement regions 284, such as a latch region 284-1, hinge regions 284-2, and bumper regions or struts 284-3 (collectively, “reinforcement regions 284”). The latch region 284-1 is configured to be coupled to a latch and/or other hardware and reinforcements for securing the lift gate in a closed position on the vehicle. The reinforcement regions 284 may be expected be subjected to higher loads. Accordingly, in certain aspects, the reinforcement regions 284 may include the substantially-aligned continuous fibers at a higher volume fractions than a remainder of the body 282.

Referring to FIG. 7B, the latch region 284-1 may include an aperture 286 configured to receive a latch. The latch region 284-1 may be further divided into multiple sub-regions, such as a first or inner sub-region 288 and a second or outer sub-region 290. The inner sub-region 288 includes a first portion 292 of the plurality of substantially-aligned continuous fibers. The outer sub-region 290 includes a second portion 294 of the plurality of substantially-aligned continuous fibers.

A first portion 292 of the plurality of substantially-aligned continuous fibers in the inner sub-region 288 are present at a first volume fraction. A second portion 294 of the plurality of substantially-aligned continuous fibers in the outer sub-region 290 are present at a second volume fraction. In certain aspects, other portions of the body 282, such as in non-connection regions 296, include a third portion of the substantially-aligned continuous fibers. The second volume fraction is different than the first volume fraction. In certain aspects, the second volume fraction is less than the first volume fraction. The third volume fraction may be different than the first and second volume fractions. For example, the third volume fraction may be less than the first and second volume fractions. The grid pattern used to depict the first and second portions 292, 294 of continuous fibers is merely a representation of differing volume fraction and is not indicative of fiber orientations.

Although the latch region 284-1 is shown and described as having two sub-regions with different volume fractions, the latch region 284-1 may alternatively include a single region or more than two sub-regions. In certain other aspects, substantially-aligned continuous fibers of a composite lift gate may having a uniform volume fraction with variable (e.g., increased) density in desired regions. Similarly, other reinforcement regions 284 may each include a single region having a different a different fiber volume fraction than surrounding regions, multiple sub-regions having different fiber volume fractions, or a uniform fiber volume fraction compared to surrounding regions. Moreover, a composite lift gate according to certain aspects of the present disclosure may include higher or lower volume fractions in regions that are different from or in addition to the reinforcement regions 284, such as higher volume fractions in expected high load regions.

A continuous fiber volume fraction may be greater than or equal to about 40% to less than or equal to about 70%, or optionally greater than or equal to about 50% to less than or equal to about 60%. For example, a continuous fiber volume fraction may be greater than or equal to about 40% to less than or equal to about 50%, greater than or equal to about 50% to less than or equal to about 60%, or greater than or equal to about 60% to less than or equal to about 70%). In certain aspects, a connection region (or another desired region) may have a volume fraction of continuous fibers of about 60% and other regions may have a continuous fiber volume fraction of about 50%.

With reference to FIG. 8, a latch assembly 320 of a lift gate according to various aspects of the present disclosure is provided. The latch assembly 320 includes a lift gate body 322, a latch 324 coupled to the body 322, and a latch reinforcement 326 coupled to the body 322. The body 322 includes a polymer matrix and a fiber assembly. The fiber assembly includes a fiber mat. The fiber assembly may also include a plurality of substantially-aligned continuous fibers, such as those described above in the discussions accompanying FIGS. 1, 2A-4, and 7A-7B. In various aspects, the body 322 may have a variable thicknesses, such as localized regions of increased thickness. Regions of the body 322 that are expected to be subjected to higher loads may have a higher thicknesses than regions of the body 322 that are expected to be subjected to lower loads.

In certain aspects, the body 322 having local regions of increased thickness allows for incorporation of tailored high-strength areas while reducing or minimizing overall weight of a composite lift gate. The local regions of increased thickness may also have variable continuous fiber density, as described above in the discussion accompanying FIGS. 7A-7B, or the variable thickness regions may have uniform continuous fiber density. For example, a reinforcement region, such as a latch connection region 328, may have both increased thickness and increased continuous fiber density compared to other regions 330 (e.g., non-reinforcement regions). Although the latch connection region 328 is shown and described as having an increased thickness, other reinforcement regions of the body 322 (e.g., hinge connection regions, struts) may additionally or alternatively have localized increased (or decreased) thicknesses.

In certain aspects, a first portion 332 of the body 322, such as the latch connection region, defines a first thickness 334. A second portion 336 of the body 322 defines a second thickness 338. The second thickness 338 may be different from the first thickness 334. For example, the second thickness 336 may be less than the first thickness 334.

In certain aspects, an increased thickness region, such as the first portion 332 of the body 322, may have a thickness of greater than or equal to about 2 mm to less than or equal to about 4 mm, by way of example. A non-reinforcement region, such as the second portion 336 of the body 322, may have a thickness of greater than or equal to about 1 mm to less than or equal to about 3 mm, by way of example

In certain aspects, the local increased thickness regions are due to local increased thickness of the substantially-aligned continuous fibers. Accordingly, the plurality of substantially-aligned continuous fibers may include a first portion having a first thickness and a second portion having a second thickness different than the first thickness. In certain aspects, the fiber mat may have a substantially uniform thickness throughout the entire body 322.

Referring to FIG. 9, a lift gate assembly 360 according to various aspects of the present disclosure is provided. The lift gate assembly 360 includes a lift gate 362 and a tether 364. The lift gate assembly 360 may further include a latch 366 and a latch reinforcement 367.

The lift gate 362 includes a body 368 having a polymer matrix and a fiber assembly embedded in the polymer matrix. The fiber assembly includes a fiber mat. The latch reinforcement 367 may be connected to the fiber mat and integrally molded with the fiber mat. The fiber assembly may also include a plurality of substantially-aligned continuous fibers, such as those described above in the discussions accompanying FIGS. 1, 2A-4, and 7A-8.

The tether 364 may extend between a first end 370 and a second end 372. The first end 370 may be coupled to a first region 374 of the body 368, such as strut or bumper reinforcement region. The second end 372 may be coupled to a second region 376 of the body 368, such as the latch reinforcement 367. In certain aspects, the first region 374 is a region having a relatively low chance of experience high loads and/or failure. Accordingly, coupling of the tether 364 to the first region 374 may facilitate retention of the lift gate 362 in a single piece and/or retention of the lift gate to a vehicle in the event of failure or high loads.

In certain aspects, the tether 364 is a fabric tether. For example the tether 364 may be formed from or include nylon, urethane, or a combination thereof. The tether may be coupled to the lift gate 362 by mechanical fasteners, by way of example. The lift gate assembly 360, including the tether 364, may be between interior and exterior panels, such as the interior and exterior panels 64, 66 of FIG. 2. Accordingly, the tether 364 may be concealed from view from an interior and an exterior of the vehicle.

In certain aspects, a lift gate may include one or more reinforcement components connected to the fiber assembly and integrally molded with the fiber assembly. According, at least a portion of the reinforcement component may be embedded in the polymer matrix. In certain aspects, the reinforcement component may be formed from or include a metal, such as steel, stainless steel, aluminum, copper, bronze, nickel, cobalt, or any combination thereof, by way of example. In one example, the reinforcement component is formed from steel or aluminum. The reinforcement components may provide high strength in region of the lift gate expected to experience high loads and/or wear. Because presence of the reinforcement components may be limited to discrete regions, a weight of the composite may be relatively low compared to a lift gate with reinforcements and/or metal throughout.

With reference to FIG. 10, a latch reinforcement component 410 according to various aspects of the present disclosure is provided. In certain aspects, the latch reinforcement component 410 may be in the form of a plate. The latch reinforcement component 410 may include a plurality of perforations or apertures 412 for coupling the latch reinforcement 412 to the fiber assembly. In certain aspects, the latch reinforcement component 410 may include additional features for receiving a latch, such as an aperture 413. The latch reinforcement 410 may additionally or alternatively include other coupling features, such as one or more depressions, channels, hooks, loops, protrusions, or any combination thereof.

In certain aspects, the latch reinforcement component 410 may be directly coupled to a fiber assembly 416, such as by stitching 418. Additionally or alternatively, the latch reinforcement component 410 may be coupled to the fiber assembly 416 by adhesive, tack-welding, bonding, such as with thermoplastic binder (e.g., applied with heat and/or pressure), or any combination thereof, by way of example. The latch reinforcement component 410 may be directly coupled to the fiber mat, the continuous fibers, or both the fiber mat and the continuous fibers.

The latch reinforcement component 410 may be coupled to the fiber assembly 416 prior to molding. The latch reinforcement component 410 and the fiber assembly 416 may be integrally molded such that a portion, such as a periphery 420 (outside of dashed line on latch reinforcement component 410), of the latch reinforcement component 410 is embedded in the polymer matrix. Coupling the latch reinforcement component 410 to the fiber assembly 416 and integrally molding the latch reinforcement component 410 with the fiber assembly 416 may facilitate retention of the latch reinforcement (and latch) to the lift gate, such as during repeated use and/or in an impact event. Although the latch reinforcement component 410 is shown and described, different or additional reinforcements (e.g., bumper reinforcements, hinge reinforcements) may also be coupled to and integrally molded with the fiber assembly 416.

A lift gate according to various aspects of the present disclosure may further include one or more electronic components connected to a fiber assembly and integrally molded with the fiber assembly. Accordingly, the electronic components may be at least partially embedded in a polymer matrix of the lift gate. The electronic components may include sensors, switches, or a combination of sensors and switches. In certain aspects, the electronic components are directly coupled to the fiber assembly, such as the fiber mat. The electronic components may be coupled to the fiber assembly by stitching, adhesive, or a combination thereof, by way of example. Coupling the electronic components to the lift gate may facilitate retention of the electronic components to the lift gate, such as during repeated use and/or an impact event.

In certain aspects, the lift gate may further include an electrically-insulating material configured to insulate the electronic component from the body, such as when the body includes conductive fibers (e.g., carbon). The insulating material may partially or fully surround or encapsulate the electronic component. In one example, the electrically-insulating material includes glass. The glass may be structured as a glass veil around the electronic component and corresponding circuitry.

Referring to FIG. 11A, a lift gate 430 according to various aspects of the present disclosure is provided. The lift gate 430 includes a body 432 having a polymer matrix and a fiber assembly embedded in the polymer matrix. The fiber assembly includes a fiber mat. The fiber assembly may further include a plurality of substantially-aligned continuous fibers, such as those described above in the discussions accompanying FIGS. 1, 2A-4, and 7A-8.

The lift gate 430 includes a proximal end 434 and a distal end 436. The proximal end 434 is configured to be pivotally coupled to a vehicle. The distal end 436 is configured to be removably coupled to the vehicle, such as by a latch 438. The lift gate 430 is configured to be moved between an open position in which the latch 438 is disengaged from a body of the vehicle and a closed position in which the latch 438 is engaged with the vehicle body. The distal end 436 includes a first surface 440 and a second surface 442. The latch 438 may project from the first surface 440.

The lift gate 430 may include one or more electronic components. For example, the lift gate 430 may include a switch 444 and a sensor 446. The electronic components may be connected to the fiber assembly and integrally molded with the fiber assembly. Accordingly, the electronic components may be at least partially embedded in the polymer matrix.

In certain aspects, the switch 444 may be in communication with a controller for moving the lift gate between the open position and the closed position. In certain aspects, the switch 444 may be used to fully open or fully close the lift gate 430. In other aspects, the switch 444 may be used to partially open or close the lift gate 430. For example, a user may depress continuously activate (e.g., depress) the switch 444 to raise or lower the lift gate 430 and release the switch 444 when the lift gate 430 is at a desired opening position. A vehicle control system may include a memory for storing the position. Subsequent activation of the switch 444 may be configured to return the lift gate to the stored position. In one example, the switch is a capacitive switch. In another example, the switch 444 is a limit switch.

The switch 444 may be coupled to the fiber assembly and integrally molded with the fiber assembly. The switch 444 may be accessible through a switch aperture 448 in the first surface 440. In certain aspects, the switch 444 and its associated circuit components are partially embedded in the polymer matrix.

In certain aspects, the sensor 446 may be configured to detect presence of an object in a closing path of the distal end 436 of the lift gate 430 (i.e., between the distal end 436 and the vehicle body). In certain aspects, the vehicle control system may be configured to stop or reverse motion of the lift gate 430 when a signal from the sensor 446 indicates presence of an object in the closing path. The vehicle control system may also alert a driver and/or a passenger that motion of the lift gate 430 was stopped or reversed.

The sensor 446 may be coupled to the fiber assembly and integrally molded with the fiber assembly. The sensor 446 may be partially or completely embedded in the polymer matrix. For example, the sensor 446 may be fully embedded in the polymer matrix and disposed adjacent to the second surface 442. In certain aspects, the sensor 446 may be a capacitive sensor.

In various aspects, the present disclosure provides a method of manufacturing a composite lift gate. The method may generally include preparing a fiber preform with a fiber mat, local substantially-aligned continuous fibers, and optionally one or more of a wire support, reinforcements, and/or electronic components. The method may further include integrally molding the fiber preform together with any of the wire support, reinforcement components, and/or electronic components, such as in a resin-transfer molding (RTM) process. With reference to FIG. 12, in various aspects, the method includes preparing a fiber assembly or preform at 500, optionally coupling one or more additional components to the fiber assembly at 504, placing the fiber assembly with additional components in a mold at 508, injecting a polymer resin into the mold at 512, crosslinking the polymer resin at 516, and optionally coupling one or more additional components to the fiber assembly at 520.

At 500, the method includes preparing a fiber assembly or preform. Preparing the fiber assembly may include connecting the fiber mat with one or more pluralities of substantially-aligned continuous fibers. Connecting may include coupling, such as by stitching the substantially-aligned continuous fibers to the fiber mat. In certain aspects, connecting may additionally or alternatively include adhesive, tack-welding, bonding, such as with thermoplastic binder (e.g., applied with heat and/or pressure), or any combination thereof, by way of example.

At 504, the method optionally includes connecting one or more additional components to the fiber assembly. In certain aspects, the additional components may include a wire support, such as a wire mesh, one or more reinforcement components, such as metal reinforcement components, and/or one or more electronic components, such as switches and/or sensors, and their associated circuit components. The additional components may be coupled to the fiber assembly, such as by stitching. In certain aspects, coupling may additionally or alternatively include adhesive, tack-welding, bonding, such as with thermoplastic binder (e.g., applied with heat and/or pressure), or any combination thereof, by way of example.

In certain aspects, the method includes connecting the wire support to the fiber mat and/or the continuous fibers. In one example, the connecting includes making slits in the fiber mat, inserting the wire mesh between layers of the fiber mat via one or more slits. The method may further include coupling the wire support to the fiber mat and/or continuous fibers, such as by stitching. In certain aspects, coupling may additionally or alternatively include adhesive, tack-welding, bonding, such as with thermoplastic binder (e.g., applied with heat and/or pressure), or any combination thereof, by way of example.

At 508, the method includes placing the fiber assembly in a mold. The mold may include two portions (e.g., halves) and be configured to be moved between an open position and a closed position. The mold may define a cavity having a desired shape of the lift gate. The fiber assembly may be placed in the mold when the mold is in an open position. The mold may subsequently be closed.

At 512, the method includes injecting a polymer resin into the mold. The polymer resin may be a thermoset polymer resin or a thermoset polymer resin, such as resins suitable for forming the polymers described above in the discussion of FIG. 1. The polymer resin may be injected at a predetermined temperature and pressure.

At 516, the method includes crosslinking the polymer resin to form the polymer matrix. The fiber assembly and optional additional components are at least partially embedded in the polymer matrix. Crosslinking may include subjecting the polymer resin to a predetermined temperature for a predetermined period of time. The crosslinking may be performed concurrently with injecting 512. The crosslinking may be performed in the mold. The lift gate may be removed from the mold.

At 520, the method may further include coupling the lift gate to one or more additional components, such as a fabric tether and/or interior and exterior panels.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A composite lift gate for a vehicle comprising:
a polymer matrix; and
a fiber assembly embedded in the polymer matrix, the fiber assembly comprising,
a fiber mat, and
a plurality of substantially-aligned continuous fibers directly connected to a portion of the fiber mat.

2. The composite lift gate of claim 1, wherein the plurality of substantially-aligned continuous fibers comprises a first plurality of substantially-aligned continuous fibers, a second plurality of substantially-aligned continuous fibers, a third plurality of substantially-aligned continuous fibers, and a fourth plurality of substantially-aligned continuous fibers arranged (i) in an M-shape, (ii) in a W-shape, or (iii) around a periphery of the composite lift gate.

3. The composite lift gate of claim 1, wherein the fiber assembly further comprises a metal mesh directly connected to the fiber mat.

4. The composite lift gate of claim 3, wherein:
the fiber mat includes a first layer and a second layer, and
the metal mesh is disposed between the first layer and the second layer.

5. The composite lift gate of claim 3, wherein:
the wire mesh includes wires having a diameter of greater than or equal to about 0.2 mm to less than or equal to about 0.5 mm, and
the wire mesh defines a mesh spacing of greater than or equal to about 1 inch to less than or equal to about 4 inches.

6. The composite lift gate of claim 3, wherein the wire mesh is stitched to the fiber mat.

7. The composite lift gate of claim 1, wherein the plurality of substantially-aligned continuous fibers comprises a first portion having a first volume fraction and a second portion having a second volume fraction different than the first volume fraction.

8. The composite lift gate of claim 1, wherein the plurality of substantially-aligned continuous fibers comprises a first portion having a first thickness and a second portion having a second thickness different than the first thickness.

9. The composite lift gate of claim 1, further comprising:
a metal reinforcement component directly connected to the fiber mat, the plurality of substantially-aligned continuous fibers, or both the fiber mat and the plurality of substantially-aligned continuous fibers and at least partially embedded in the polymer matrix.

10. The composite lift gate of claim 9, wherein the metal reinforcement component is stitched to the fiber mat.

11. A lift gate assembly comprising:
the composite lift gate of claim 1;
a tether comprising a first end coupled to a first region of the composite lift gate and a second end coupled to a second region of the composite lift gate different than the first region;
a first panel; and
a second panel, wherein the composite lift gate and the tether are disposed between the first panel and the second panel.

12. The lift gate assembly of claim 11, wherein the tether comprises fabric.

13. The composite lift gate of claim 1, wherein the fiber mat comprises a chopped fiber mat, a non-crimp fabric, or both a chopped fiber mat and a non-crimped fabric.

14. The composite lift gate of claim 1, wherein the polymer matrix comprises a thermoset polymer.

15. The composite lift gate of claim 1, further comprising:
an electronic component connected to the fiber assembly, the electronic component being selected from the group consisting of: a sensor, a switch, or any combination thereof, wherein the electronic component is at least partially embedded in the polymer matrix.

16. The composite lift gate of claim 15, further comprising:
an electrically-insulating material configured to insulate the electronic component from the fiber assembly.

17. A method of manufacturing a composite lift gate for a vehicle, the method comprising:
preparing a fiber preform by connecting a plurality of substantially-aligned continuous fibers to a fiber mat;
disposing the fiber preform in a mold;
injecting a polymer precursor into the mold; and
forming the composite lift gate by crosslinking the polymer precursor to form a polymer matrix, the fiber preform being embedded in the polymer matrix.

18. The method of claim 17, wherein the preparing further includes directly connecting a metal mesh to the fiber mat.

19. The method of claim 17, further comprising:
prior to the injecting, connecting a metal reinforcement component to the fiber preform.

20. The method of claim 17, further comprising:
prior to the injecting, connecting an electronic component to the fiber preform.
